(19) United States
(12) Patent Application Publication
(10) Pub. No.: US 2007/0033320 A1
(43) Pub. Date: Feb. 8, 2007

(54) Crypto pass-through dangle

(76) Inventors: Victor Chuan-Chen Wu, Cupertino, CA (US); Bill Kwong, Saratoga, CA (US)

Correspondence Address: Dougherty & Troxell;ONE SKYLINE PLACE, SUITE 1404, 5205 LEESBURG PIKE, FALLS CHURCH, VA, 22041, US

(21) Appl. No.: 11/197,364

(22) Filed: Aug. 5, 2005

(51) Int. Cl. G06F 12/00

(52) U.S. Cl. 711/100

(57) ABSTRACT

A crypto pass-through dangle that enables various memory devices with USB interface to be conveniently inserted into or removed from with encryption/decryption function, which comprising: a housing, having an upper housing and a lower cover that can be mutually engaged together for forming a space, wherein the housing further comprises a first opening and a second opening; a printed circuit board, disposed in the space; a first connector, disposed on the printed circuit board and exposed outward the first opening for being inserted into or removed from a USB slot of a host computer; a controller, disposed on the printed circuit board and coupled to the first connector for receiving data from the first connector or transmitting data to the first connector and executing encryption/decryption operation then output; and a second connector, disposed on the printed circuit board and coupled to the controller for connecting the controller to a memory device with a USB interface.

### BACKGROUND OF THE INVENTION

1. Field of the Invention

The present invention relates to a crypto pass-through dangle that enables various memory devices with USB interface, such as a flash memory card or a flash memory storage device can be encrypted or decrypted so as to achieve the goal of protecting the data of the memory device with USB interface.

2. Description of Related Art

Accompanying the science and technology developing, the chip with USB interface 2.0 protocol has higher speed and lower price, so many computer manufacturers have equipped the USB interface 2.0 protocol in their computer system.

The memory card manufacturers had already produced many various type of memory cards, such as SmartMedia, CompactFlash, MMC, Security Digital (SD), Memory Stick, Memory Stick Pro, xD or Microdrive, Memory Stick Duo and Memory Stick Pro Duo memory card etc., however the memory cards can be accessed through a card reader, therefore, the user must buy a card reader for accessing the memory cards, thus, it will increase the user's burden and make the wire connection of the computer system become more complex. The memory card with USB interface can be directly plugged into the USB port of the computer system for accessing without needs a card reader; therefore, in the future many memory card manufacturers will produce various type memory cards with USB interface.

The flash memory storage device with USB interface, similar to the memory card with USB interface, can be directly plugged into the USB port of the computer system for accessing, additionally, due to its size can be up to more than 1 GB and have popular sales price, so the flash memory storage device with USB interface becomes more and more popular.

For example, the U.S. Pat. No. 6,889,209 issued to Rabin, et al. disclosed a ^{┌}Method and apparatus for protecting information and privacy_{┘}, wherein the method for supervising usage of software on a user device comprising the steps of: computing, by a supervising program within the user device, a first hash function value of a tag table; sending, by the supervising program, a call-up message to a guardian center, the call up message comprising the first hash function value, an identifier value of the tag table, and a second hash function value of the tag table sent in a previous call-up message; verifying, by the guardian center, that the hash function value of the tag table sent in the previous call-up message is a most recently stored value in a list of hash function values stored by the guardian center and associated with the identifier value of the tag table; upon successful verification by the guardian center, appending the received first tag table hash function value to the list of hash function values associated with the identifier value of the tag table; and sending, by the guardian center, a continuation message to the supervising program, the continuation message comprising a super fingerprint and a portion of the call-up message to detect and halt the duplication of a tag table on several user devices; the super fingerprint comprising a list of hash functions resulting from hashes performed on software, a weight value W which defines how many times the supervising program should run, program P and conditions that the supervising program must hold in order to run P, and computer programs used by the supervising program to detect invalidly running software. The aforesaid patent discloses a method for supervising usage of software on a user device, but not a flash memory storage device with USB interface has data encryption/decryption function.

For example, the U.S. Pat. No. 5,956,194 issued to Ohmi, et al. disclosed a ^{┌}Data storage apparatus_{┘}, wherein the data storage apparatus (HDD unit) having a cartridge, attachable to and detachable from a personal computer, incorporating a recording disk, comprises a switch circuit for inhibiting data reading and writing with respect to a magnetic disk and a locking mechanism for detecting that the cartridge is detached from the personal computer and causing a data reading and writing inhibiting device to operate in response to the detection. The aforesaid patent discloses a data storage apparatus comprising a locking mechanism for detecting that the cartridge is detached from the personal computer and causing a data reading and writing inhibiting device to operate in response to the detection, however the aforesaid patent is used in HDD field not in flash memory storage device field, furthermore, the aforesaid patent also dose not have data encryption/ decryption function.

The prior art flash memory devices with USB interface, such as memory cards or flash memory storage devices did not have the ability to protect the data of them being read by other users, so the owner must keep his/her flash memory devices with USB interface very carefully, and prevent his/her flash memory devices with USB interface from losing, due to the data of the flash memory devices with USB interface can be directly read by being plugged into a USB port of a host computer, therefore, the prior art flash memory devices with USB interface could not meet the requirement of data security.

There is therefore a need for a new and improved strategy and technique for overcoming these deficiencies and the present invention overcomes these deficiencies in a new and novel fashion.

### SUMMARY OF THE INVENTION

The present invention generally relates to a strategy and a technique, which overcomes some or all of the above referenced deficiencies associated with prior memory card reader.

It is a first non-limited object of the present invention is to provide a crypto pass-through dangle that enables various types of memory devices with USB interface can be encrypted or decrypted.

According to one non-limited embodiment of the present invention, the crypto pass-through dangle that enables various memory devices with USB interface to be conveniently inserted into or removed from with encryption/decryption function, which comprising: a housing, having an upper housing and a lower cover that can be mutually engaged together for forming a space, wherein the housing further comprises a first opening and a second opening; a printed circuit board , disposed in the space; a first connector, disposed on the printed circuit board and exposed outward the first opening for being inserted into or removed from a USB slot of a host computer; a controller, disposed on the printed circuit board and coupled to the first connector for receiving data from the first connector or transmitting data to the first connector and executing encryption/decryption operation then output; and a second connector, disposed on the printed circuit board and coupled to the controller for connecting the controller to a memory device with a USB interface.

### BRIEF DESCRIPTION OF THE DRAWINGS

The present invention can be more fully understood by reference of the following description and accompanying drawings, in which:

FIG. 1 illustrates an exploded view of the crypto pass-through dangle in accordance with one embodiment of the present invention.

FIG. 2 illustrates an assembly appearance of the crypto pass-through dangle in accordance with one embodiment of the present invention.

FIG. 3 illustrates the enlarged view of the crypto pass-through dangle being plugged into a USB slot of a host computer, and then flash memory devices with USB interface being plugged into a USB slot of the crypto pass-through dangle in accordance with one embodiment of the present invention.

FIG. 4, illustrates an exploded view of the USB interface storage apparatus with encryption/decryption function in accordance with another embodiment of the present invention.

FIG. 5, illustrates the enlarge appearance of the USB interface storage apparatus with encryption/decryption function being plugged into a USB slot 71 of a host computer 70, and then a flash memory card 89 being plugged into the second connector 86 in accordance with one embodiment of the present invention.

FIG. 6, illustrates an exploded view of the USB interface storage apparatus 90 with encryption/decryption function in accordance with still one embodiment of the present invention.

FIG. 7, illustrates the enlarge appearance of the USB interface storage apparatus 90 with encryption/decryption function being plugged into a USB slot 71 of a host computer 70 in accordance with still one embodiment of the present invention.

### DETAILED DESCRIPTION OF THE PREFERRED EMBODIMENTS

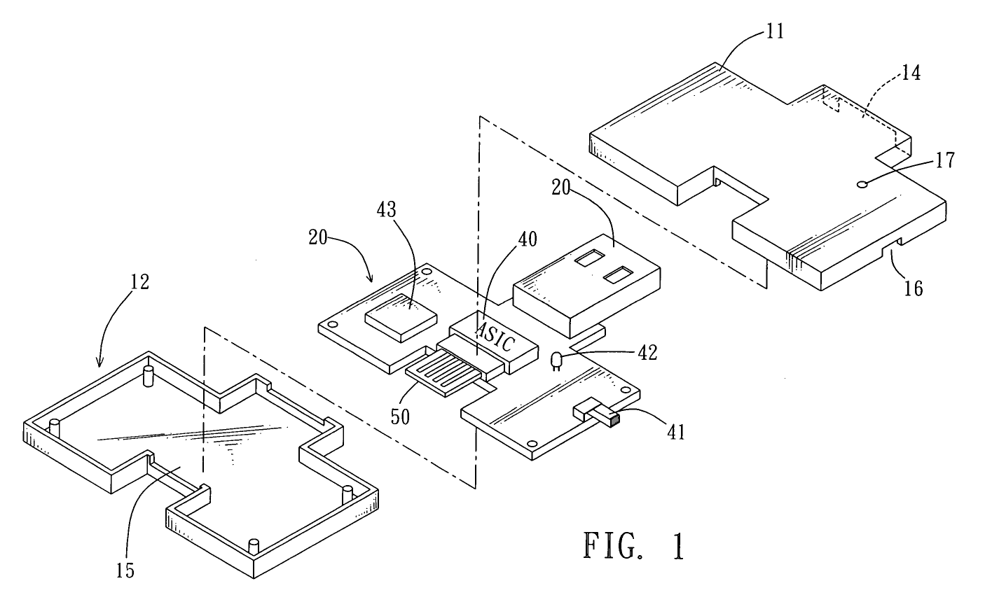

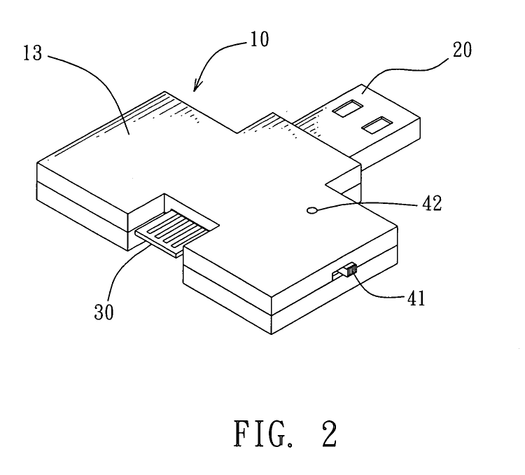

Referring to FIG. 1, which illustrates an exploded view of the crypto pass-through dangle in accordance with one embodiment of the present invention; as shown in FIG. 1, the crypto pass-through dangle of the present invention that enables various memory devices with USB interface to be conveniently inserted into or removed from with encryption/decryption function, which comprising: a housing 10 (please refer to FIG. 2); a printed circuit board 20; a first connector 30; a controller 40 and a second connector 50.

Wherein, the housing 10 is made of plastic material, preferably, and has an upper housing 11 and a lower cover 12 that can be mutually engaged together for forming a space 13 (please refer to FIG. 2), wherein the housing 10 further comprises a first opening 14 disposed at the front side of the housing 10, and a second opening 15 disposed at the rear side of the housing 10; wherein, the first opening 14 is used for providing the first connector 30 being exposed, and the second opening 15 is used for providing the second connector 50 being exposed. The housing 10, for example but not limited to the upper housing 11, further comprise a third opening 16 and a hole 17.

The printed circuit board 20 is disposed in the space 13 for conveying the first connector 30, controller 40 and second connector 50.

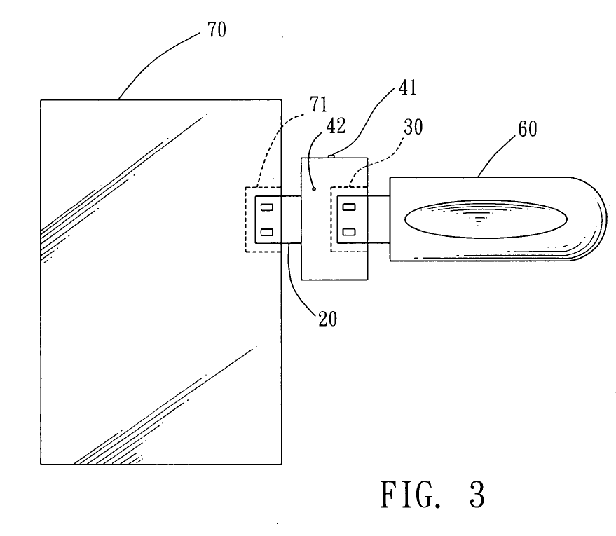

The first connector 30 is disposed on the printed circuit board 20 and exposed outward the opening 14 for being plugged into a USB port slot of a host computer 70 (please refer to FIG. 3). Wherein, the first connector 30 is a USB interface connector.

The controller 40 is disposed on the printed circuit board 20 and coupled to the first connector 30 and the second connector 50 for receiving data from the first connector 30 or transmitting data to the first connector 30 and executing data encryption/decryption operation then output. Wherein the controller 40 is an Application Specification Integrated Circuit (ASIC) with USB interface and has data encryption and decryption ability. The controller 40 executes the encryption/ decryption function according to a DES protocol, which uses 64 bits, 128 bits or 192 bits length to execute data encryption/decryption function. For example, if the controller 40 uses 64 bits to execute data encryption/decryption function, it will generate an identity code with 8 bytes for the flash memory device, wherein the identity code has 264 combinations, if the encrypted flash memory device 60 being directly plugged into the USB port slot 71 of a host computer 70 (please refer to FIG. 3), due to the USB port slot 71 of the host computer 70 can not recognize the identity code, so the computer 70 can not access the data of the encrypted flash memory device 60, therefore, the data of the flash memory device 60 can be protected. If the encrypted flash memory device 60 being plugged into the crypto pass-through dangle of the present invention, the controller 40 can recognize the identity code and execute the decrypting function for the data; therefore, the computer 70 can access the data of the encrypted flash memory device 60.

Furthermore, the crypto pass-through dangle of the present invention also comprises a storage device 43, for example but not limited to a EEPROM, which is coupled to the controller 40 for store the identity code generated by the controller 40.

The second connector 50 is disposed on the printed circuit board 20 and coupled to the controller 40 for connecting the crypto pass-through dangle of the present invention to a flash memory device with USB interface 60. Wherein, the second connector 50 is a USB interface slot.

Referring to FIG. 2, which illustrates assembly appearance of the crypto pass-through dangle in accordance with one embodiment of the present invention;

as shown in FIG. 2, while assembling the crypto pass-through dangle of the present invention, the printed circuit board 20 with the first connector 30, controller 40 and second connector 50 is firstly disposed and fastened in the space 13 of the lower housing 12, and then covers the upper housing 11 to the lower housing 12 and let the first connector 30 be exposed outward the opening 14, the second connector 50 be exposed outward the opening 15.

For controlling the controller 40 to execute data encryption/decryption function, the crypto pass-through dangle of the present invention further comprises a switch 41 disposed on the printed circuit board 20 and exposed outward the third opening 16 as well as coupled to the controller 40 for controlling the controller 40 whether executes the data encryption/decryption function or not. The controller 40 will execute the data encryption/decryption function when the switch 41 is turned to an on position, while the controller 40 will not execute the data encryption/decryption function when the switch 41 is turned to an off position, so the crypto pass-through dangle of the present invention could execute data encryption/decryption function to the flash memory device with USB interface 60 according the status of the switch 41.

Furthermore, the crypto pass-through dangle of the present invention further comprises an indicator 42, for example but not limited to a LED, disposed on the printed circuit board 20 and protruded from the hole 17 for indicating the access status of the controller 40.

Referring to FIG. 3, which illustrates the enlarge appearance of the crypto pass-through dangle being plugged into a USB slot 71 of a host computer 70, and then a flash memory devices with USB interface 60 being plugged into a USB slot 50 of the crypto pass-through dangle in accordance with one embodiment of the present invention; as shown in the FIG. 3, while operating, the user can plug the crypto pass-through dangle of the present invention into a USB port 71 of a host computer 70, then plugs the flash memory device with USB interface 60 into the second connector 50 of the crypto pass-through dangle; if the user wants to enable the encryption/decryption function of the crypto pass-through dangle, he/she can turn the switch 41 to the on position, then the controller 40 will execute data encryption/decryption function according to the DES protocol described above to prevent the data of the flash memory device with USB interface 60 from being incorrectly accessed, so as to achieve the goal of data protecting; if the users does not want to enable the encryption/decryption function of the crypto pass-through dangle, he/she can turn the switch 41 to an off position, then the controller 40 will not execute data encryption/decryption function, so the data of the flash memory device with USB interface 60 can be accessed as normal flash memory device with USB interface, and the data of the flash memory device with USB interface 60 will have no security function.

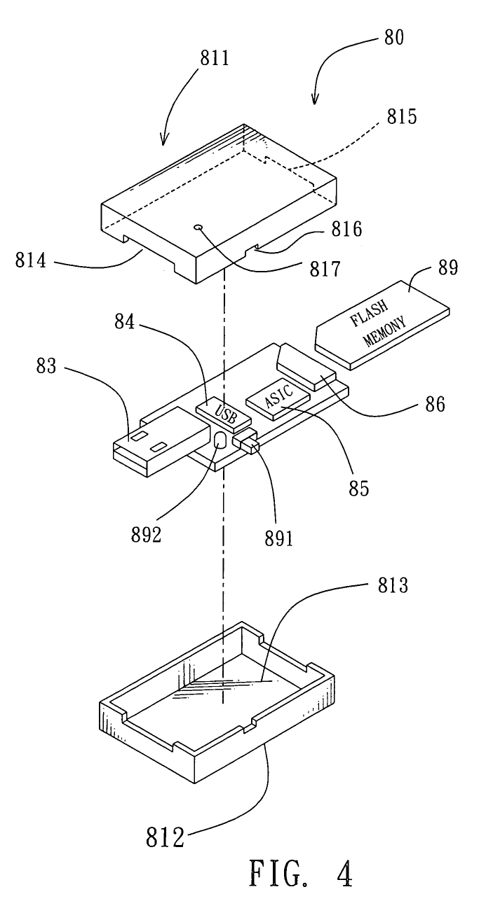

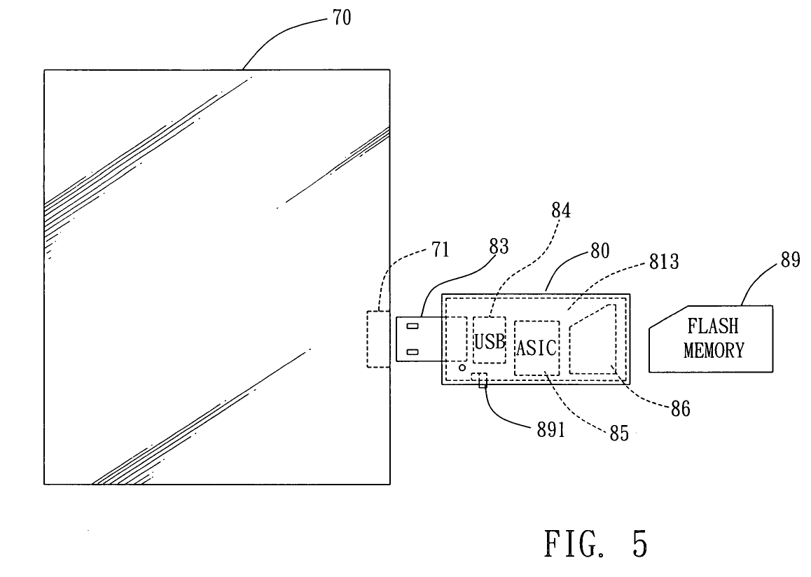

Referring to FIG. 4, which illustrates an exploded view of the USB interface storage apparatus with encryption/decryption function in accordance with another embodiment of the present invention; as shown in FIG. 4, the USB interface storage apparatus 80 with encryption/decryption function of the present invention comprises: a housing 81; a printed circuit board 82; a first connector 83; a USB controller 84; an encryption/decryption controller 85; and a second connector 86.

Wherein, the housing 81 is made of plastic material, preferably, and has an upper housing 811 and a lower cover 812 that can be mutually engaged together for forming a space 813 (please refer to FIG. 5), wherein the housing 81 further comprises a first opening 814 disposed at the front side of the housing 81, and a second opening 815 disposed at the rear side of the housing 81; wherein, the first opening 814 is used for providing the first connector 83 being exposed, and the second opening 815 is used for providing the second connector 86 being exposed. The housing 81, for example but not limited to the upper housing 811, further comprise a third opening 816 and a hole 817.

The printed circuit board 82 is disposed in the space 813 for conveying the first connector 83, USB controller 84, encryption/decryption controller 85 and second connector 86.

The first connector 83 is disposed on the printed circuit board 82 and exposed outward the opening 814 for being plugged into a USB port slot of a host computer 70 (please refer to FIG. 5). Wherein, the first connector 83 is a USB interface connector.

The USB controller 84 is disposed on the printed circuit board 82 and coupled to the first connector 83 for receiving data from the first connector 83 or transmitting data to the first connector 83. Wherein the USB controller 84 is an Application Specification Integrated Circuit (ASIC) with USB interface.

The encryption/decryption controller 85 is disposed on the printed circuit board 82 and coupled to the USB controller 83 for executing encryption/decryption operation then output. The encryption/decryption controller 85 executes the encryption/decryption function according to a DES protocol, which uses 64 bits, 128 bits or 192 bits length to execute data encryption/decryption function. The detail description of the DES protocol please refer to the aforesaid description.

The second connector 86 is disposed on the printed circuit board 82 and coupled to the encryption/decryption controller 85 as well as exposed outward the second opening 815 for providing a memory device 89 being inserted into or removed from. Wherein, the memory device 89 is a Compact Flash, MMC, Security Digital(SD), Memory Stick, Memory Stick Pro, xD or Microdrive memory card, preferably.

Furthermore, it further comprises a switch 891 disposed on the printed circuit board 82 and exposed the third opening 816 as well as coupled to the encryption/decryption controller 85 for controlling the encryption/decryption controller 84 whether executes the data encryption/decryption function or not.

Furthermore, the USB interface storage apparatus 80 of the present invention further comprises an indicator 892, for example but not limited to a LED, disposed on the printed circuit board 82 and protruded from the hole 817 for indicating the access status of the USB controller 84 or encryption/decryption controller 85.

Referring to FIG. 5, which illustrates the enlarge appearance of the USB interface storage apparatus with encryption/decryption function being plugged into a USB slot 71 of a host computer 70, and then a flash memory card 89 being plugged into the second connector 86 in accordance with one embodiment of the present invention; as shown in the FIG. 5, while operating, the user can plug the USB interface storage apparatus 80 with encryption/decryption function of the present invention into a USB port 71 of a host computer 70, then plugs the flash memory card 89 with USB interface 60 into the second connector 86 of the USB interface storage apparatus 80, wherein, the the flash memory card 89 is for example but not limited to a Compact Flash, MMC, Security Digital(SD), Memory Stick, Memory Stick Pro, xD or Microdrive memory card; if the user wants to enable the encryption/decryption function of the USB interface storage apparatus, he/she can turn the switch 891 to the on position, then the encryption/decryption controller 85 will execute data encryption/decryption function according to the DES protocol described above to prevent the data of the flash memory card 89 from being incorrectly accessed, so as to achieve the goal of data protecting; if the users does not want to enable the encryption/decryption function of the USB interface storage apparatus, he/she can turn the switch 891 to an off position, then the encryption/decryption controller 85 will not execute data encryption/decryption function, so the data of the flash memory card 89 can be accessed as normal flash memory device, and the data of the flash memory card 89 will have no security function.

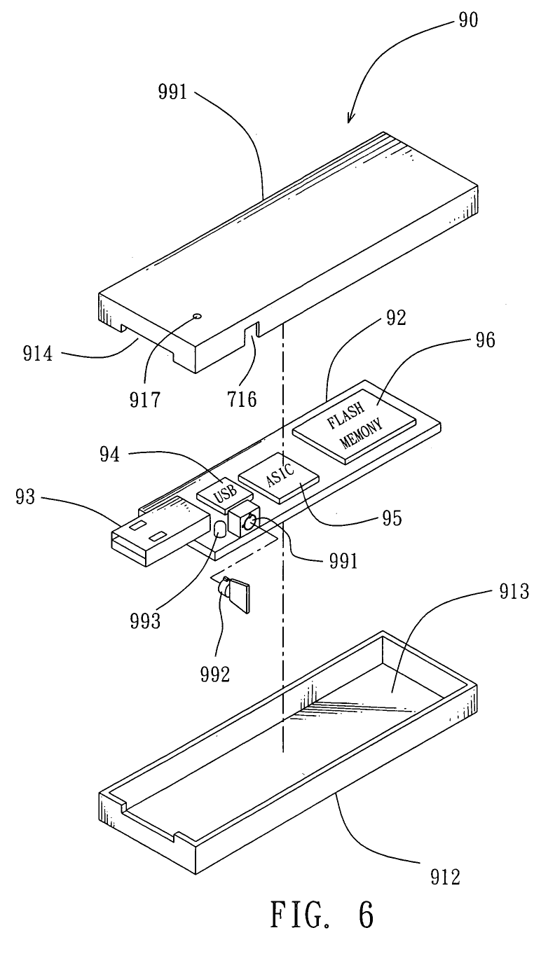

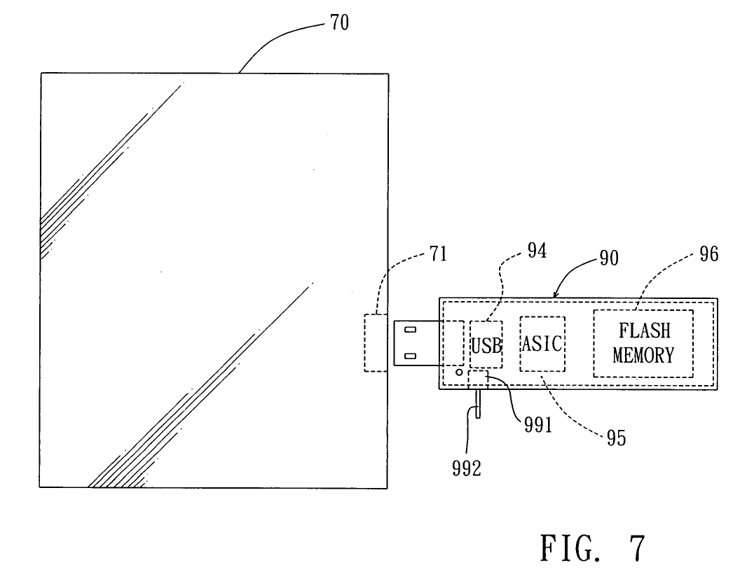

Referring to FIG. 6, which illustrates an exploded view of the USB interface storage apparatus 90 with encryption/decryption function in accordance with still one embodiment of the present invention; as shown in FIG. 6, the USB interface storage apparatus 90 with encryption/decryption function of the present invention comprises: a housing 91; a printed circuit board 92; a first connector 93; a USB controller 94; an encryption/decryption controller 95; and a memory 96.

Wherein, the housing 91 is made of plastic material, preferably, and has an upper housing 911 and a lower cover 912 that can be mutually engaged together for forming a space 913 (please refer to FIG. 7), wherein the housing 91 further comprises a first opening 914 disposed at the front side of the housing 91; wherein, the first opening 914 is used for providing the first connector 93 being exposed. The housing 91, for example but not limited to the upper housing 911, further comprise a second opening 916 and a hole 917.

The printed circuit board 92 is disposed in the space 913 for conveying the first connector 93, USB controller 94, encryption/decryption controller 95 and memory 96.

The first connector 93 is disposed on the printed circuit board 92 and exposed outward the opening 914 for being plugged into a USB port slot of a host computer 70 (please refer to FIG. 7). Wherein, the first connector 94 is a USB interface connector.

The USB controller 95 is disposed on the printed circuit board 92 and coupled to the first connector 93 for receiving data from the first connector 93 or transmitting data to the first connector 93; Wherein the USB controller 94 is an Application Specification Integrated Circuit (ASIC) with USB interface.

The encryption/decryption controller 95 is disposed on the printed circuit board 92 and coupled to the USB controller 94 for executing encryption/decryption operation then output. The encryption/decryption controller 95 executes the encryption/decryption function according to a DES protocol, which uses 64 bits, 128 bits or 192 bits length to execute data encryption/decryption function. The detail description of the DES protocol please refer to the aforesaid description.

The memory 96 is disposed on the printed circuit board 92 and coupled to the encryption/decryption controller 95 for storing data. Wherein, the memory 96 is for example but not limited to a flash memory.

Furthermore, the USB interface storage apparatus 90 of the present invention further comprises a lock seat 991 disposed on the printed circuit board 92 and exposed the second opening 916 as well as coupled to the encryption/decryption controller 95 for controlling the encryption/decryption controller 95 whether executes the data encryption/decryption function or not. Thus the memory 96 of the USB interface storage apparatus 90 will be encrypted/decrypted when the encryption/decryption function of the controller 95 is enabled by using a key 992 inserting into the lock seat 991 and turning to an ON position and the memory 96 can not be read without using the key 992 so as to achieve the goal of protecting the data of the memory 96. Furthermore, the key 992 further comprises a unique identity code (ID), it will be transferred to the controller 95 for executing ID comparing when the key 992 is inserted into the lock seat 991 and turned to the ON position. Therefore, the data of the memory 96 will be saved if the user lost the USB interface storage apparatus 90 unless using the key 992.

Furthermore, the USB interface storage apparatus 90 of the present invention further comprises an indicator 993, for example but not limited to a LED, disposed on the printed circuit board 92 and protruded from the hole 917 for indicating the access status of the USB controller 94 or encryption/decryption controller 95.

Referring to FIG. 7, which illustrates the enlarge appearance of the USB interface storage apparatus 90 with encryption/decryption function being plugged into a USB slot 71 of a host computer 70 in accordance with still one embodiment of the present invention; as shown in the FIG. 7, while operating, the user can plug the USB interface storage apparatus 90 with encryption/decryption function of the present invention into a USB port 71 of a host computer 70; if the user wants to enable the encryption/decryption function of the USB interface storage apparatus 90, he/she can insert the key 992 into the lock seat 991 and turned it to the ON position, then the encryption/decryption controller 95 will compare the ID transferred from the key 992, if it is correct then the controller 95 will execute data encryption/decryption function according to the DES protocol described above to prevent the data of the flash memory 96 from being incorrectly accessed, so as to achieve the goal of data protecting; if the user does not want to use the USB interface storage apparatus 90, he/she can turn the lock seat 991 to an OFF position and remove the key 991, then the data of the memory 96 will not be accessed due to the controller 95 can not get the correct ID transferred from the key 992. Therefore, the data of the memory 96 will be saved if the user lost the USB interface storage apparatus 90 unless using the key 992.

While the invention has been disclosed with reference to preferred embodiments thereof, it is to be understood that modifications or variations may be easily made without departing from the spirit of this invention, which is defined in the appended claims.

What is claimed is:

1. A crypto pass-through dangle that enables various memory devices with USB interface to be conveniently inserted into or removed from with encryption/decryption function, which comprising:
a housing, having an upper housing and a lower cover that can be mutually engaged together for forming a space, wherein the housing further comprises a first opening and a second opening;
a printed circuit board , disposed in said space;
a first connector, disposed on said printed circuit board and exposed outward said first opening for being inserted into or removed from a USB slot of a host computer;
a controller, disposed on said printed circuit board and coupled to said first connector for receiving data from said first connector or transmitting data to said first connector and executing encryption/decryption operation then output; and
a second connector, disposed on said printed circuit board and coupled to said controller for connecting said controller to a memory device with a USB interface.

2. The crypto pass-through dangle according to claim 1, wherein said housing is made of plastic material, preferably.

3. The crypto pass-through dangle according to claim 1, wherein said memory device is a flash memory card or a flash memory storage device with a USB interface.

4. The crypto pass-through dangle according to claim 1, wherein said first connector is a USB interface connector, and said second connector is a USB interface slot.

5. The crypto pass-through dangle according to claim 1, wherein it further comprise a third opening and a hole disposed on said housing, and a power indicator disposed in said hole and coupled to said controller for indication the access status of said controller.

6. The crypto pass-through dangle according to claim 1, wherein said controller is an Application Specification Integrated Circuit with USB interface and has ability to execute data encryption/decryption function.

7. The crypto pass-through dangle according to claim 6, wherein said controller executes said encryption/decryption function according to a DES protocol.

8. The crypto pass-through dangle according to claim 7, wherein said DES protocol uses 64 bits, 128 bits or 192 bits length to execute data encryption/decryption function.

9. The crypto pass-through dangle according to claim 5, wherein it further comprises a switch disposed on said printed circuit board and exposed said third opening as well as coupled to said controller for controlling said controller whether executes said data encryption/decryption function or not.

10. The crypto pass-through dangle according to claim 1, wherein it further comprises a storage device coupled to said controller for storing said identity code generated by said controller.

11. The crypto pass-through dangle according to claim 10, wherein said storage device is a EEPROM.

12. A USB interface storage apparatus with encryption/decryption function, which comprising:
a housing, having an upper housing and a lower cover that can be mutually engaged together for forming a space, wherein said housing further comprises a first opening and a second opening;
a printed circuit board , disposed in said space;
a first connector, disposed on said printed circuit board and exposed outward said first opening for being inserted into or removed from a USB slot of a host computer;
a USB controller, disposed on said printed circuit board and coupled to said first connector for receiving data from said first connector or transmitting data to said first connector;
an encryption/decryption controller, disposed on said printed circuit board and coupled to said USB controller for executing encryption/decryption operation then output; and
a second connector, disposed on said printed circuit board and coupled to said encryption/decryption controller as well as exposed outward said second opening for providing a memory device being inserted into or removed from.

13. The USB interface storage apparatus with encryption/decryption function according to claim 12, wherein said first connector is a USB connector, said second connector is a Compact Flash, MMC, Security Digital(SD), Memory Stick, Memory Stick Pro, xD or Microdrive memory card connector preferably.

14. The USB interface storage apparatus with encryption/decryption function according to claim 12, wherein said encryption/decryption controller executes said encryption/decryption function according to a DES protocol, wherein said DES protocol uses 64 bits, 128 bits or 192 bits length to execute data encryption/decryption function.

15. The USB interface storage apparatus with encryption/decryption function according to claim 12, wherein said housing further comprises a third opening, and a it further comprises a switch disposed on said printed circuit board and exposed said third opening as well as coupled to said encryption/decryption controller for controlling said encryption/decryption controller whether executes said data encryption/decryption function or not.

16. A USB interface storage apparatus with encryption/decryption function, which comprising:
a housing, having an upper housing and a lower cover that can be mutually engaged together for forming a space, wherein said housing further comprises a first opening;
a printed circuit board , disposed in said space;
a first connector, disposed on said printed circuit board and exposed outward said first opening for being inserted into or removed from a USB slot of a host computer;
a USB controller, disposed on said printed circuit board and coupled to said first connector for receiving data from said first connector or transmitting data to said first connector;
an encryption/decryption controller, disposed on said printed circuit board and coupled to said USB controller for executing encryption/decryption operation then output; and
a memory, disposed on said printed circuit board and coupled to said encryption/decryption controller for storing data.

17. The USB interface storage apparatus with encryption/decryption function according to claim 16, wherein said first connector is a USB connector.

18. The USB interface storage apparatus with encryption/decryption function according to claim 16, wherein said encryption/decryption controller executes said encryption/decryption function according to a DES protocol, wherein said DES protocol uses 64 bits, 128 bits or 192 bits length to execute data encryption/decryption function.

19. The USB interface storage apparatus with encryption/decryption function according to claim 16, wherein said housing further comprises a second opening, and a it further comprises a lock seat disposed on said printed circuit board and exposed said second opening as well as coupled to said encryption/decryption controller for controlling said encryption/decryption controller whether executes said data encryption/decryption function or not.

20. The USB interface storage apparatus with encryption/decryption function according to claim 19, wherein it further comprises a key, which contains a unique identity code and could be inserted into said lock seat and transferred said identity code to said encryption/decryption controller for controlling said encryption/decryption controller executing said encryption/decryption function or not.
